(19) United States
(12) Patent Application Publication
(10) Pub. No.: US 2007/0189879 A1
(43) Pub. Date: Aug. 16, 2007

(54) Drain proof washer

(76) Inventor: Mao-Chang Lin, Taichung Hisen (TW)

Correspondence Address: MAO-CHANG LIN, 235 Chung-Ho Box 8-24, Taipei, TW

(21) Appl. No.: 11/353,194

(22) Filed: Feb. 14, 2006

(51) Int. Cl. F16B 43/02

(52) U.S. Cl. 411/542

(57) ABSTRACT

A drain proof washer for sealing water within a filter is disclosed. The drain proof washer is installed at an opening of the filter and is installed between the opening of the filter and a water tube so that water will not drain out from a connection between the opening and the water tube. The drain proof washer comprises a circular ring having an approximate-rectangular cross section; the angle of each of three corners of the approximate-rectangular cross section of the ring being 90 degree and an outer surface of the ring is smooth without any hair. The other corner is a convex round edge.

### FIELD OF THE INVENTION

The present invention relates to washers, and particularly to a drain proof washer, wherein the drain proof washer comprises a circular ring having an approximate-rectangular cross section; the angle of each of three corners of the approximate-rectangular cross section of the ring being 90 degrees and an outer surface of the ring being smooth without any hair. The other corner is a convex round edge. Thus, the drain proof washer can tightly seal an opening of a filter.

### BACKGROUND OF THE INVENTION

In a prior art filter, the filter has a cap which is screwed to a cylinder which has a filter material, or the filter is formed by filling filtering material in a sealing container. The prior art filter has an opening. Water flows through the opening of the filter and then through the filtering material. The opening has a joint for connecting a tube. A drain proof washer is installed between the opening and the joint. The water flow opening has a round cross section, as shown in FIG. 1. In manufacturing of the drain proof washer, several hundreds washers are made by injection molding at one time. As a result, if the mold do not have precise sizes or the connections of the parts of the molds have errors or gaps, some washers will not have precise sizes as washers are far away from the central shaft of the mold in the manufacturing process. Furthermore, if the washer has a haired surface due the manufacturing process, the washer can not tightly engage with the opening of the filter and the tube, water will drain out. As a result, the user must apply a great force to the washer. However this will induce the deformation of the washer. For a long time, a great gap will generate at the place between the washer, tube and opening of the filter and thus the drainage of water is deteriorated.

Referring to FIGS. 2 and 3, the prior art drain proof washer is applied, which is applied to a filter. The drain proof washer 4 is applied within a joint 2. The joint 2 is a structure to a water flow opening 10 of a cap 1 of a filter. A T shape cap 31 resists against the drain proof washer 4. A front end of the T shape cap 31 is formed with a plurality of claws 310 spaced by slits 311. A front end of the T shape cap 31 is elastic so that it can be easily placed into the water tube 2 and resist against the drain proof washer 4. Thus, the drain proof washer 4 has the effect of drain proof to the water in the filter.

Referring to FIGS. 4 and 5, another arrangement is illustrated. In this prior art, a toggle 5 encloses an outer side of the T shape cap 31 and then a C shape clamp 500 encloses the toggle so as to fix the T shape cap 31 to prevent the movement of the drain proof washer 4. However it is illustrated that the drain proof washer 4 has a round cross section so that it is in point-contact with the inner side of the cap 1. Thereby the washer 4 has haired surfaces. Thus the contact between the drain proof washer 4 and the inner side of the cap 1 is not as tight as to completely seal the water within the filter. Therefore, the prior art design is not a preferred one. The prior art can not completely seal water within the filter.

### SUMMARY OF THE INVENTION

Accordingly, the primary object of the present invention is to provide a drain proof washer, wherein the drain proof washer can tightly seal an opening of a filter and moreover, the washer can be reused many times.

To achieve above objects, the present invention provides a drain proof washer for sealing water within a filter, the drain proof washer being installed at an opening of the filter and being installed between the opening of the filter and a water tube so that water will not drain out from a connection between the opening and the water tube. The drain proof washer comprises a circular ring having an approximate-rectangular cross section; the angle of each of three corners of the approximate-rectangular cross section of the ring being 90 degree and an outer surface of the ring being smooth without any hair. The other corner is a convex round edge.

The various objects and advantages of the present invention will be more readily understood from the following detailed description when read in conjunction with the appended drawing.

### BRIEF DESCRIPTION OF THE DRAWINGS

FIG. 1 is a schematic cross sectional view of a prior art washer.

FIG. 2 is a schematic perspective view of the prior art washer.

FIG. 3 is an assembled enlarged view of the FIG. 2.

FIG. 4 is an structural assembled view of the prior art washer.

FIG. 5 is an assembled enlarged view of FIG. 4.

FIG. 6 is an exploded perspective view of the present invention.

FIG. 7 is an enlarged cross sectional view of the present invention.

FIG. 8 is an application view of the present invention.

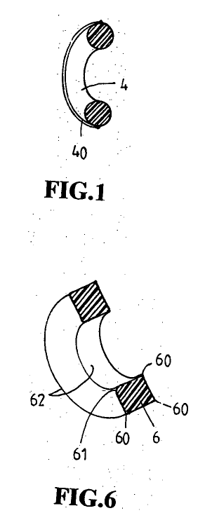

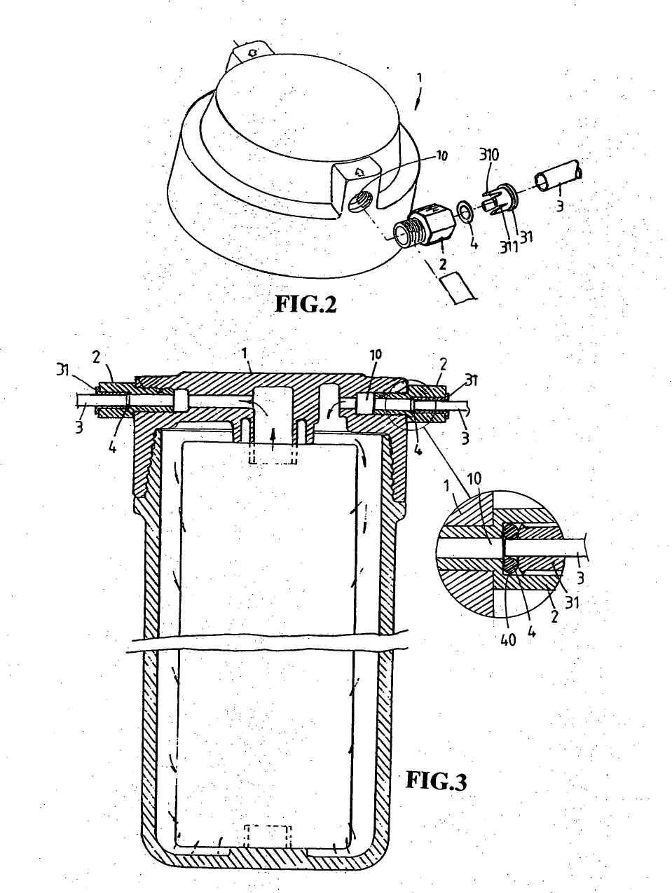

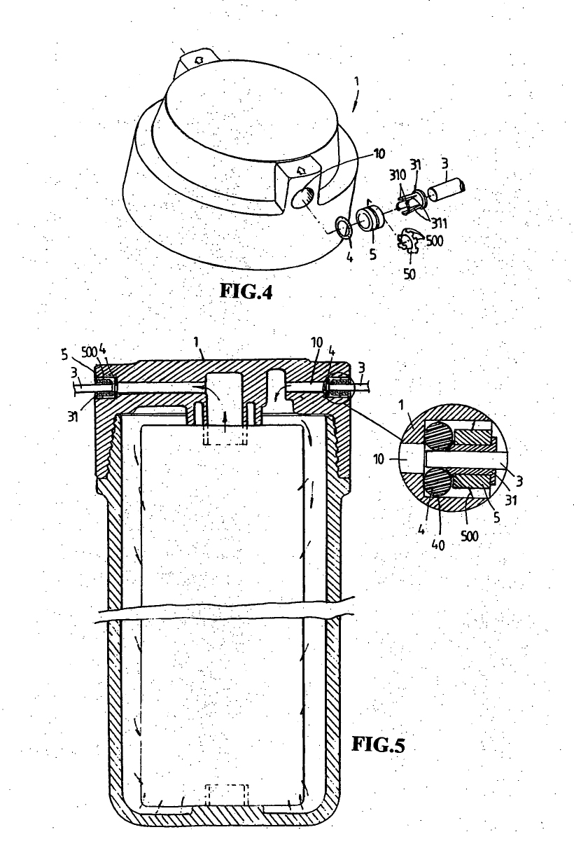

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

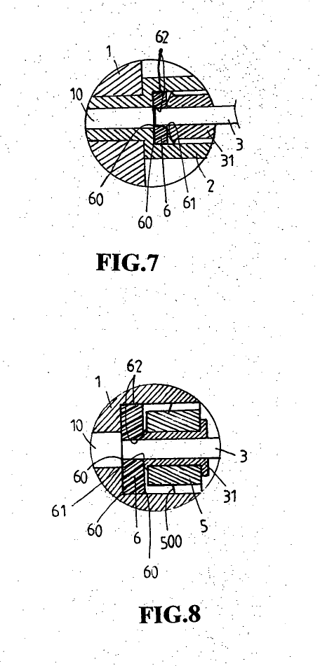

Referring to FIGS. 6 and 7, the drain proof washer of the present invention is illustrated.

A circular ring 6 has an approximate-rectangular cross section as illustrated in FIG. 6. The angle of each of three corners of the approximate-rectangular cross section of the ring 6 is 90 degrees and the other corner is a convex round edge 61. An outer surface of the ring 6 is a smooth surface 62 without hairs.

Referring to FIGS. 7 and 8, when the present invention is applied to a water flow opening 10 of a casing 1 of a filter or a filter cover or to a water tube 3, and the present invention is used to seal a filter 1, the drain proof washer 6 is placed at a water flow opening 10 of the filter 1. The convex cambered corner is placed at a side far away from the water flow opening 10 so that a water tube 3 can be placed at the side having a round corner smoothly and resists against the drain proof washer 10 of the present invention tightly. The corners having 90 degree sides resists against an inner side of the filter 1. Thus, water within the filter will not drain out.

In FIG. 7, it is illustrated that a T shape cap 31 encloses the outer periphery of the water tube 3. In FIG. 8, it is illustrated that a toggle and a clamp 500 serve to further close the water tube 3 so as to fix the water tube 3 tightly. In these two cases, the drain proof washer of the present invention can have preferred effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A drain proof washer for sealing water within a filter, the drain proof washer being installed at an opening of the filter and being installed between the opening of the filter and a water tube so that water will not drain out from a connection between the opening and the water tube; the drain proof washer comprising:
a circular ring having an approximate-rectangular cross section; the angle of each of three corners of the approximate-rectangular cross section of the ring being 90 degrees and an outer surface of the ring being smooth without any hair.

2. The drain proof washer as claimed in claim 1, wherein the other corner is a convex round edge.
